(19) United States
(12) Patent Application Publication
(10) Pub. No.: US 2003/0187540 A1
(43) Pub. Date: Oct. 2, 2003

(54) Automated roof truss component saw

(76) Inventor: James F. Urmson, Eustis, FL (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/396,624

(22) Filed: Mar. 26, 2003

Related U.S. Application Data
(63) Continuation of application No. 09/630,310, filed on Jul. 31, 2000.

(51) Int. Cl. G06F 19/00

(52) U.S. Cl. 700/167

(57) ABSTRACT

My automated saw apparatus for cuffing the component pieces for roof trusses. The apparatus comprises a circular power saw, a processing line whereon stock lumber is conveyed to and from the saw, a waste bin for receiving scrap pieces cut by and discarded from the saw, a control computer and software, and sensors for measuring the lumber as it is conveyed to the saw for allowing the computer to determine how long a board to cut, and where and at what angles to make the cuts.

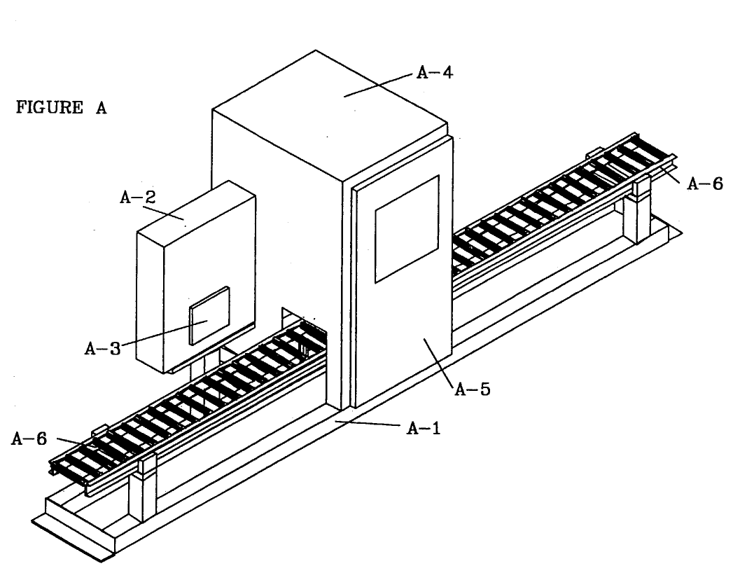

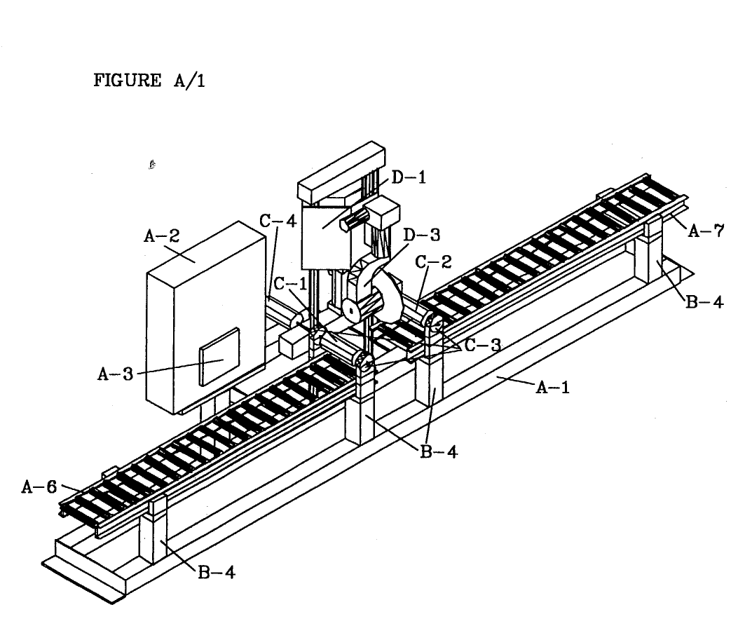

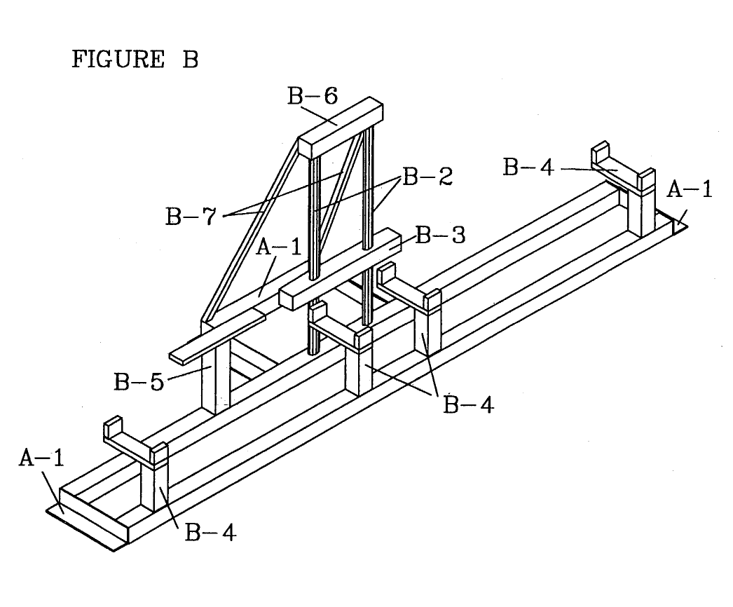

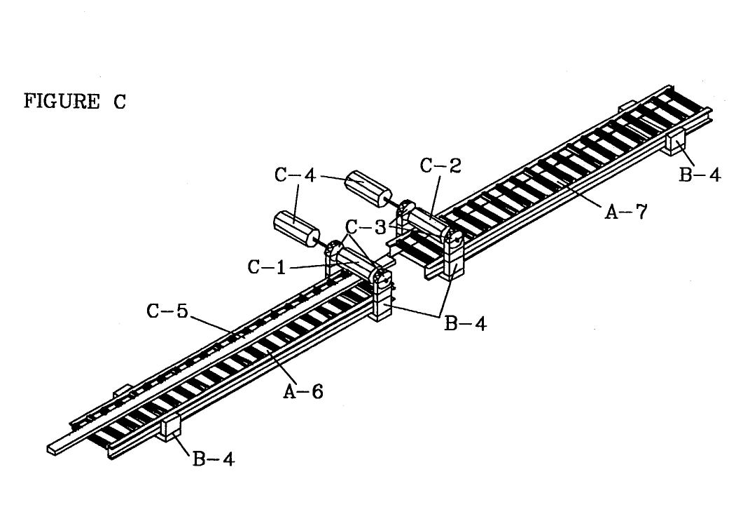

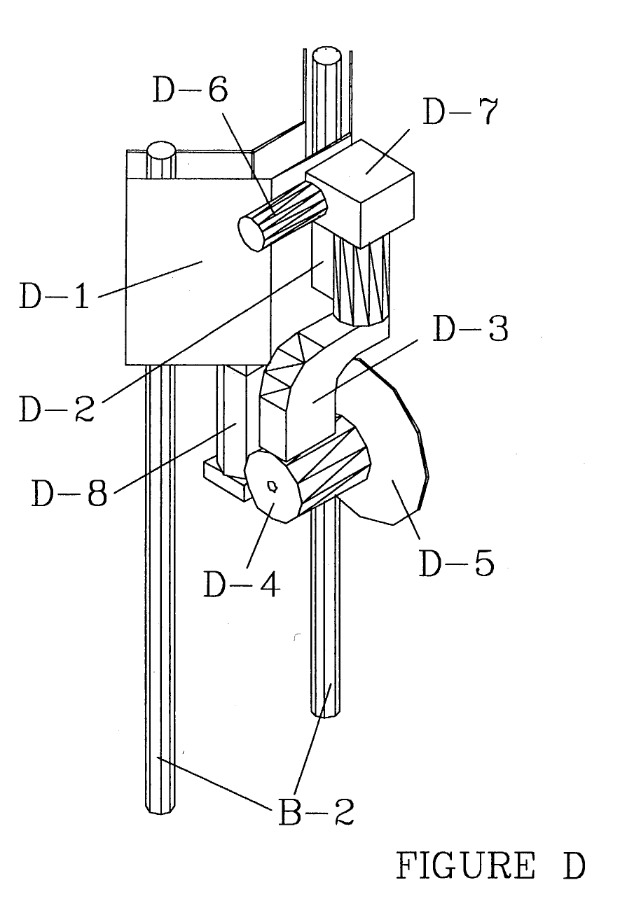

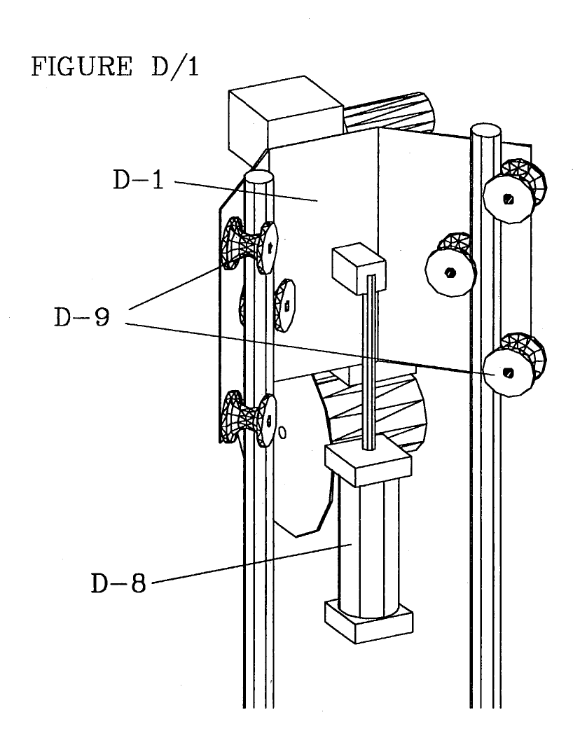

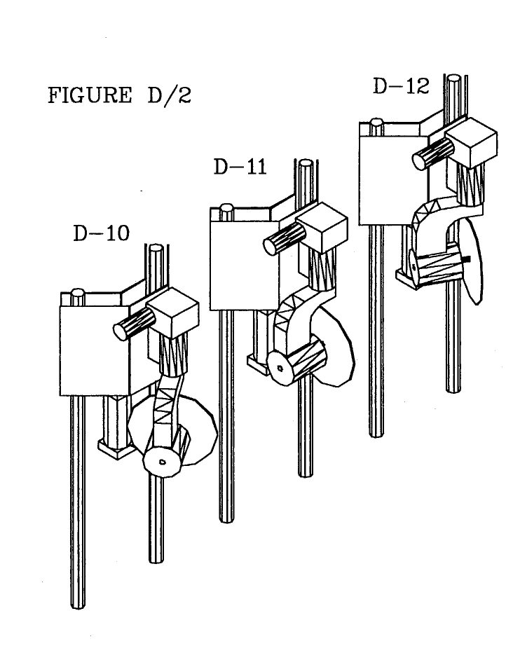

This is a continuation of Ser. No. 09/630,310 filed on Jul. 31, 2000, from which the Applicant claims priority.

### BACKGROUND FIELD OF INVENTION

The present invention relates to computer controlled, automated power saws. Specifically, those saws used in the manufacture of engineered wood roof and floor trusses. Truss components of this type require a wide variety of lengths and angle cuts. The criteria for a successful saw in today's market would have to include, but not be limited to, safety, speed, accuracy, durability and low operator cost.

### REFERENCES CITED

U.S. Pat. No. 5,365,812—Harden, Charles, Nov. 22, 1994

U.S. Pat. No. 5,176,060—Thornton, Jack L., Jan. 5, 1993

U.S. Pat. No. 4,454,794—Thornton, Jack L., Jun. 19, 1984

U.S. Pat. No. 4,036,093—Thorsell, Roland H., Jul. 19, 1977

U.S. Pat. No. 3,910,142—Jureit, John C., Oct. 7, 1975

### BACKGROUND DESCRIPTION OF PRIOR ART

There are several saws available to truss builders today—some manual and some computer controlled. The driving force in innovation is to increase production and accuracy as well as decrease labor cost.

An example is that of Harden, U.S. Pat. No. 5,365,812. Harden discloses a saw pivoting on a centerline, but moving in a horizontal cutting motion requiring excessive movement to complete a cut. The saw is also unable to angulate until fully retracted. The lumber cannot be cut on both ends without the operator manually rotating it horizontally and inserting it back into the saw. The Harden saw is computer-controlled but requires repetitive operator input to initiate successive functions.

The Thornton saw, U.S. Pat. No. 5,176,060, is a two-blade saw with no computer control. All angles and work piece lengths are set manually. The machine is efficient at making repetitive cuts producing identical pieces but slow manual setup time makes it impractical. The previous Thornton saw, U.S. Pat. No. 4,454,794, is a similar machine, although it is a single-blade saw. It is also manually set with the same limitations as the two-blade saw.

The Thorsell machine, U.S. Pat. No. 4,036,093, cuts in a vertical motion, although operated by means of electric motors and lead screws, which are prone towards fouling with saw dust. The structure of the saw frame is not designed to eliminate lateral deflection at the saw blade making it difficult to ensure accuracy.

The Jureit saw, U.S. Pat. No. 3,910,142, is very similar to the Harden machine referred to earlier. This saw operates in the same manner, although was not able to make use of the current PC technology. The Jureit saw also requires excessive operator input.

### SUMMARY

The invention discloses an automated saw apparatus for cutting the component pieces for roof trusses. The apparatus comprises a circular power saw, a processing line whereon stock lumber is conveyed to and from the saw, a waste bin for receiving scrap pieces cut by and discarded from the saw, a control computer and software, and sensors for measuring the lumber as it is conveyed to the saw for allowing the computer to determine how long a board to cut, and where and at what angles to make the cuts.

### OBJECTS AND ADVANTAGES

Accordingly several objects and advantages are as follows, the truss component saw herein described automatically stores, interpolates and displays to the operator data necessary to perform the task of cutting truss component members. As truss component members are by necessity comprised of many different lengths as well as various angle configurations it is necessary that the machine be tractable in its movement as well as conservative of its motion.

An object of the present invention is to perform multiple functions with one apparatus as in the feed conveyors. The feed rollers convey the lumber in and out of the saw as well as measure, position and hold the wood in place as the cut is made.

Another object is to make efficient use of readily available cutting data from the truss engineering program without time-consuming operator input. This is accomplished by using the computer to select the order of cut and give an uninterrupted flow of operation.

A further object and advantage is to angulate the saw head by means of a servo motor coupled to a ninety degree worm gear drive. This configuration, which has no exposed moving parts, is not subject to fouling by sawdust. The servo motor and worm gear drive combination also, as before, performs multiple functions as it sets the angle of cut as well as locks the cut head in position to insure an accurate cut. The rotational play caused by clearance between the gear teeth is compensated for in the motion control software.

Another object is to construct a saw that is a self-contained unit, capable of being transported easily and requiring no excessive setup procedure. This is accomplished by providing a rigid self-supporting frame to which all the saw components are attached. The saw requires no leveling, calibrating nor does it need to be bolted to a concrete base.

A still further object pertains to safety. All of the saw's moving parts are housed within a heavy gauge steel cabinet whose door is equipped with an electronic safety lock and all the electrical components are housed within heavy gauge steel, dustproof enclosures.

### DRAWING FIGURES

FIG. (A) illustrates the saw with safety enclosures in place. “A-i” is the base welded steel structure that makes up the saw frame. “A-2” is the dustproof electronic cabinet which holds all computer components as well as motor control hardware. “A-3” is the operator panel, which includes the operator control switches and computer interface controls as well as the computer monitor. “A-4” is the saw safety enclosure, which is comprised of steel panels that fully enclose all the moving parts, as well as limit the dispersal of sawdust into the work environment. “A-5” is the enclosure access door, which is also constructed of steel and equipped with an electronic safety lock to block access to the saw while it is operating as well as disabling saw startup while the door is open.

“A-6” and “A-7” are roller conveyors which are supported on tension springs and allow lumber to feed in with little drag.

FIG. (A/1) shows the saw with the safety enclosure removed, exposing the moving parts to view. “A-1” is the welded steel frame. “A-2” is the electronic cabinet. “A-3” is the operator panel. “A-6” and “A-7” are the roller conveyors.

“B-4” shows the four feed roller cradles which support parts “A-6” and “A-7” as well as provide a mounting base for “C-3” feed roller pillow block bearings.

“C-1” is the infeed roller and “C-2” is the outfeed roller, both of which are controlled by the “C-4” servo motors. Roller carriage ‘D-1” which allows the saw to perform the up/down movement necessary to perform the cut, is comprised of a heavy plate steel frame with six radius cut rollers “D-9” (not pictured).

“D-3” the offset motor mount is set in tapered roller bearings to allow the saw motor to easily pivot 180 degrees and offset to allow the blade to pivot on a centerline. FIG. (B) shows the bare frame. All components in this view are welded to make a suitably rigid one-piece structure. The parts are as follows, “A-1” steel base, “B-2” the tube steel vertical support tubes, “B-3” mounting block, “B-4” roller conveyor cradle, “B-5” electronic cabinet pedestal, “B-6” tube steel support cap and “B-7” support cap braces.

FIG. (C) depicts the feed roller assembly, which is made up of the “C-1” and “C-2” feed rollers, which are knurled steel rollers supported by “C-3” pillow block bearings bolted to supports “B-4” feed roller cradles which also support parts “A-6” and “A-7” roller conveyors. The item “C-5” illustrates the placement of lumber into the machine. FIG. (D) shows the roller carriage/saw head assembly. The “D-1” roller carriage support Li consists of a front and back section and provides mounting for the six radius cut rollers that mate to the “B-2” support tubes.

The “D-2” pivot head bearing assembly bolts directly to the carriage support and holds the pivot shaft of “D-3” offset motor mount. The “D-5” saw blade which is attached to the shaft of “D-4” saw motor is positioned directly below and inline with the pivot shaft as to make it possible to pivot on its centerline. Attached to the upper pivot shaft is the “D-7” reduction drive, which is turned by “D-6” pivot head servo motor.

Also shown is the “D-8” vertical saw carriage pneumatic cylinder, which raises and lowers the carriage assembly as needed to perform the cuts.

FIG. (D/1) is a rear look at the carriage assembly with the back section of the “D-1” carriage support removed to show the “D-9” radius cut saw carriage rollers and the attachment of “D-8” Vertical saw carriage pneumatic cylinder.

FIG. (D/2) illustrates the pivoting movement of the of the saw head “D-10” shows the saw set to make a 60 degree cut, “D-11” a 90 degree cut and “D-12” a 120 degree cut.

List reference numerals
Figure (A)

| | |
|---|---|
| A-1 | Saw frame |
| A-2 | Electronic cabinet |
| A-3 | Operator panel |
| A-4 | Saw enclosure |
| A-5 | Enclosure access door |
| A-6 | Infeed roller conveyor |
| A-7 | Outfeed roller conveyor |

Figure (A/1)

| | |
|---|---|
| A-1 | Saw frame |
| A-2 | Electronic cabinet |
| A-3 | Operator panel |
| A-6 | Infeed roller conveyor |
| A-7 | Outfeed roller conveyor |
| B-4 | Feed roller cradle |
| C-1 | In feed roller |
| C-2 | Outfeed roller |
| C-4 | Feed roller servo motors |
| D-1 | Roller carriage support |
| D-3 | Offset motor mount |

Figure (B)

| | |
|---|---|
| A-1 | Welded steel base |
| B-2 | Tube steel vertical support tubes |
| B-3 | Mounting block |
| B-4 | Feed roller cradle |
| B-5 | Electronic cabinet pedestal |
| B-6 | Tube steel support cap |
| B-7 | Support cap braces |

Figure (C)

| | |
|---|---|
| C-1 | Infeed roller |
| C-2 | Outfeed roller |
| C-3 | Feed roller pillow block bearings |
| C-4 | Feed roller servo motors |
| C-5 | Lumber on inked conveyor |
| A-6 | Conveyor roller |
| A-7 | Conveyor roller |
| B-4 | Feed roller cradle |

Figure (D)

| | |
|---|---|
| D-1 | Roller carriage support |
| D-2 | Pivot head bearing assembly |
| D-3 | Offset motor mount |
| D-4 | Saw motor |
| D-5 | Saw blade |
| D-6 | Pivot head servo motor |
| D-7 | 90 degree worm gear reduction drive |
| D-8 | Vertical saw carriage pneumatic cylinder |
| B-2 | Tub War vertical support tubes |

Figure (D/1)

| | |
|---|---|
| D-1 | Roller carriage support |
| D-8 | Vertical saw carriage pneumatic cylinder |
| D-9 | Radius cut saw carriage rollers |

Figure (D/2)

| | |
|---|---|
| D-10 | Saw head set for a 60 degree cut |
| D-11 | Sawhead set fora9o degree cut |
| D-12 | Saw head set for a 120 degree cut |

Operation of Automated Roof Truss Component Saw

The saw is started by switching the main disconnect to “ON.” This switch is mounted on the control panel (FIG. A-3). This will power up the saw and computer. The computer will then boot up and open the. saw program. The operator will then select a data “CUT” file from the “JOBS” menu and the system will load the selected data into the program.

The operator will then activated the “START SAW” and START CYCLE” buttons on said control panel and as the “READY” sign comes up on the LCD monitor the lumber can be fed into the infeed roller (FIG. C-1). The device will automatically measure and set the angles of cut as prescribed in the input data as well as pneumatically raise and lower the saw head performing the cuts until it has used up the lumber inserted into the saw. The device will then redisplay the “Ready” sign and the operator will feed another piece of lumber into the machine. This action will continue until the “JOB” is finished. On the outfeed end of the machine, the operator will mark the web designation on the finished workpiece (lumber) or affix a printed label as needed. He will then stack the finished piece on the lumber cart and repeat the cycle until finished.

Description of Automated Roof Truss Component Saw

A saw frame (FIG. A) made up of heavy wall square steel tubing, welded to make a rigid frame capable of supporting all saw components. Extending from the base are two parallel machined tubes (FIG. B-2) that make up a track allowing the saw assembly to move in a smooth up and down direction, minimizing any lateral deflection, yet allowing enough clearance as to not be fouled by an accumulation of saw dust. Said base allows for six areas (FIG. A-1) to level and bolt saw frame to a suitable floor although leveling and bolting are not necessary for the operation of said saw. Extending from the front of the base are four conveyor cradles (FIG. B-4); they are designed to support the weight and insure alignment of the conveyor assembly.

A roller conveyor assembly (FIG. C) set at waist height as to aid operator comfort in loading and unloading of work pieces (lumber), comprised of a spring mounted roller conveyor (FIGS. A-6,A-7)on the infeed and outfeed ends of the machine. Said conveyors (FIGS. A-6, A-7) are spring mounted to insure close contact between the workpiece (lumber) and the feed rollers. Mounted in closest proximity to the saw blade are two feed rollers (FIGS. C-I, C-2), which are knurled to eliminate slippage as lumber is fed through the saw. Supporting said feed rollers are pillow blocks (FIG. C-3) which bolt to the conveyor supports (FIG. B-4). Directly above and off-center to the rear of said roller conveyor is an adjustable fence (not pictured) to insure proper alignment of the work piece. Attached to the input shaft of said feed rollers are a servo motor and planetary gear drive (FIG. B-4). These control the movement of the workpiece (lumber), as well as measurement of said workpiece. These servo motors are wired to the servo amplifier (not pictured) in the control cabinet (FIG. A-2).

A roller carriage assembly (FIG. D) consisting of a roller frame and rollers (FIGS. D-1, D-9) whose rollers move against a round steel tube track (FIG. B-2) at a close tolerance fit as to eliminate any lateral deflection. Attached to this frame is a pivot head bearing assembly (FIG. D-2) which holds an upper and lower tapered roller bearing (bearings not pictured). These bearings allow the saw blade to pivot on a centerline in relation to the work piece (lumber). Extending vertically up through the inner race of these bearings is a solid steel shaft, which is attached to the offset motor mount (FIG. D-3). Said motor mount is offset as to hold the blade (FIG. D-5) centerline directly below and aligned with the motor mount pivot shaft. Attached to and set at right angles to said motor mount pivot shaft is the saw motor (FIG. D-4). It is a dustproof electric motor of sufficient horsepower to perform the work. Attached to the output shaft of said saw motor is the saw blade (FIG. D-5), it is a standard steel blade. Holding said blade to the shaft are 8″ flat washers (not pictured) to minimize blade distortion.

Attached to the top of said motor mount pivot shaft is the worm gear reduction drive (FIG. D-7). It turns at 50:1 reduction, and has a hollow output shaft allowing the pivot shaft to mount directly to the reduction drive. Mounted to the input shalt of said reduction drive is a permanent magnet servo motor (FIG. D-6). This motor is used to set and holds the saw at the prescribed angles (see FIG. D-2 saw set at three angles.). The servo motor is wired to the servo amplifier (not pictured) in the control cabinet (FIG. A-2).

The saw has various sensors to initiate and regulate automatic function. They are as follows: A proximity switch mounted under the input feed table (FIG. A-6) to signal that lumber has been fed into the machine thus initiating the automatic cycle. Two proximity switches mounted to the roller carriage frame—(FIG. D) to sense up and down limits to carriage travel. Two proximity switches mounted to the motor mount pivot shaft (FIG. D-3) to sense limits in the pivot angle.

A fail-safe limit switch to activate an emergency stop condition if said saw head rotates beyond usable limits.—The control cabinet (FIG. A-2) houses all the electronics for the machine. These include: The computer which is an IBM compatible PC, a LCD monitor mounted in the door of the cabinet, three servo amplifiers, power supplies, one three phase motor starter, one 50 amp main disconnect, ventilation fan and filter, various terminal blocks, fuse blocks and relays.

The pneumatic system consists of two functions. The first is a large bore pneumatic cyclinder (FIG. D-8) that cycles the roller carriage assembly (FIG. D) in an up-down direction, dropping the saw blade into the lumber below it, thus making a cut. Said cylinder is charged in the up direction only, the weight of the saw causes it to drop as the air is released by the #1 pneumatic valve (not pictured). The second function is that of clamping the lumber in place against the fence as it is being cut. This is performed by two small clamping cylinders (not pictured), which are controlled together by pneumatic valve #2 (not pictured).

Conclusion

The reader should see from the preceding information that the invention fulfills the criteria mentioned in the background field of invention to produce a saw with the qualities of safety, speed, accuracy, durability and low operator cost. This saw combines the foremost advantage of current computer technology with a minimum of mechanical complexity to accomplish just that.

I claim as my invention:

1. An automated system for fabricating truss component members from lumber, said system comprising:
(a) a saw head automatically actuated in a angular and vertical directions within a cutting area of the saw head, and for cutting lumber into truss component members;
(b) a conveyor system connected to the saw head for automatically delivering lumber into said cutting area;
(c) a controller, in electrical communication with the saw head and conveyor system, controlling the automated movement of the saw head and the automated movement of the conveyor system to cut the lumber into truss components;
(d) at least one sensor, in electrical communication with the controller, detecting the presence of the lumber approaching the cutting area of the saw head, and sending at least one signal to the controller indicative of the presence of the lumber and in response to the detection thereof; and,
(e) a database, accessible by the controller, comprising data representative of at least one command for the automated movement of the conveyer system, and the automated movement of saw head, and in accordance with a set of predetermined cutting dimensions to cut the lumber into said truss component members.

2. The automated system of claim 1 wherein said conveyer system comprises a conveyor carriage and at least one roller in spaced relation to the carriage and proximal to the cutting area, the roller engaging the lumber and controlling the delivery of the lumber into the cutting area, and the roller being automatically actuated by the controller and in accordance with the predetermined cutting coordinates, and delivering lumber to the cutting area.

3. The automated system of claim 2 further comprising at least one servomotor, in electrical communication with the controller and the roller, and activated by the controller in response to the signal received from the sensor detecting the lumber on the conveyor system approaching the cutting area and in accordance with the predetermined cutting dimensions.

4. The automated system of claim 1 further comprising at least one sensor positioned proximal the saw head detecting vertically disposition of the saw head, and generating a signal in response to the detection thereof.

5. The automated system of claim 1 further comprising at least one sensor positioned proximal the saw head detecting angular disposition of the saw head, and generating a signal in response to the detection thereof.

6. The automated system of claim 1 wherein the controller comprises an operator interface for inputting commands representative of at least one cutting dimension for the truss component members.

7. The automated system of claim 1 wherein said conveyor system comprises a lumber input conveyor carriage and a first roller in spaced relation to the input conveyor carriage and proximal to the cutting area, and an output conveyor carriage and a second roller in spaced relation to the output conveyor carriage and proximal the cutting area, and the first roller and second roller automatically actuated by the controller, in accordance with the predetermined cutting dimensions, respectively delivering lumber to the cutting area and removing truss component members from the cutting area.

8. The automated system of claim 7 further comprising a first servomotor, in electrical communication with the controller and first roller, and a second servomotor in electrical communication with the controller and second roller, the first servomotor and second servomotor activated by the controller in response to the signal received from the sensor detecting the lumber on the conveyor system approaching the cutting area, and in accordance with the predetermined cutting dimensions.

9. A method for cutting lumber into truss component members using an automated saw head, an automated conveyer system and a controller programmed to control the movement of the saw head and conveyor system, the method comprising the steps of:
(a) providing a database, accessible by the controller, and having data representative of predetermined dimensions of truss component members and commands associated with the automated actuation of the conveyor system and saw head cut the lumber into truss components in accordance with said dimensions;
(b) positioning lumber on the conveyor system; and,
(c) activating the controller to deliver the lumber on the conveyor system to a cutting area, and to actuate the saw head to cut the lumber into said truss component members, in accordance with said predetermined dimensions and responsive to said commands.

10. The method of claim 9 further comprising the steps of detecting the presence of lumber approaching the cutting area, generating a signal to the controller and responsive to the detection of the lumber, and activating the conveyor system responsive to the signal to deliver the lumber into the cutting area in accordance with said predetermined dimensions.

11. The method of claim 10 wherein the step of activating the conveyor system continues as long as lumber is detected to cut the lumber in accordance with the dimensions.

12. The method of claim 9 further comprising the step of providing at least one sensor proximal the conveyor system for detecting a presence of lumber approaching the cutting area, generating a signal to the controller responsive to the detection of the lumber and activating the conveyor system responsive to the signal to deliver the lumber into the cutting area in accordance with said predetermined dimensions.

13. The method of claim 9 further comprising the step of deactivating the conveyor system when the lumber has been cut into said predetermined dimensions and the sensor no longer detects lumber available for cutting in accordance with the predetermined dimensions.

14. The method of claim 9 further comprising the step of inputting a parameter into the controller representative of a known length of at least one piece of lumber to be cut, and deactivating the conveyor system when the saw head has cut a maximum number of truss component members from said at least one piece of lumber within said known length.

15. A method for cutting lumber into truss component members, the method comprising the steps of:
(a) providing a conveyor system for delivery of the lumber to a cutting area within which the lumber is cut;
(b) providing a saw head for cutting the lumber into said truss component members;
(c) providing a controller for controlling the automated actuation of the conveyor system and the saw head;
(d) providing a database, accessible by the controller, and having data representative of dimensions of truss component members and commands associated with the automated actuation of the conveyor system and saw head to cut the lumber into truss components in accordance with said dimensions;
(e) providing a sensor proximal the conveyor system for detecting the presence of lumber on the conveyor system;
(g) generating a signal indicative of the presence of the lumber on the conveyor system and the signal being communicated to the controller; and,
(h) said controller actuating the conveyor system and the saw head responsive to the signal to cut the lumber into truss components in accordance with said predetermined cutting dimensions.

16. The method of claim 15 further comprising the steps of providing a servomotor in electrical communication with the controller for the automated actuation of the conveyor system to deliver lumber to the cutting area for cutting the lumber in accordance with the predetermined dimensions.

17. The method of claim 15 further comprising the step of inputting a parameter into the controller representative of a known length of at least one piece of lumber to be cut, and deactivating the conveyor system when the saw head has cut a maximum number of truss component members from said at least one piece of lumber within said known length.
